(19) United States
(12) Patent Application Publication
(10) Pub. No.: US 2023/0131033 A1
(43) Pub. Date: Apr. 27, 2023

(54) Method of Managing Sliding Region of Electrode

(71) Applicant: LG Energy Solution, Ltd., Seoul (KR)

(72) Inventors: Seung Gi Yang, Daejeon (KR); Ung Ju Lee, Daejeon (KR)

(73) Assignee: LG Energy Solution, Ltd., Seoul (KR)

(21) Appl. No.: 17/907,855

(22) PCT Filed: Oct. 27, 2021
(86) PCT No.: PCT/KR2021/015240

§ 371 Date: Aug. 29, 2022

(30) Foreign Application Priority Data
Oct. 30, 2020 (KR) 10-2020-0142659

(51) Int. Cl. H01M 4/36

(52) U.S. Cl. CPC H01M 4/364; H01M 2004/027

(57) ABSTRACT

The present technology relates to a method of managing a sliding region of an electrode, and the method includes: determining a specific region where a positive electrode and a negative electrode, which are subjects of management to be used in manufacturing an electrode assembly, face each other and setting a measurement location in the specific region; measuring a thickness and a loading amount of each electrode mixture layer of the positive electrode and the negative electrode at the set measurement location; measuring a thickness and a loading amount of an electrode mixture layer at each central portion of the positive electrode and the negative electrode; and calculating a ratio of the thickness of the electrode mixture layer of the positive electrode and the negative electrode to the thickness of the central portion.

### CROSS-REFERENCE TO RELATED APPLICATIONS

This application is a national stage entry under 35 U.S.C. § 371 of International Ptent Application No. PCT/KR2021/015240, filed on Oct. 27, 2021, which claims priority to Korean Patent Application No. 10-2020-0142659, filed on Oct. 30, 2020, the entire contents of which are hereby incorporated herein by reference.

### TECHNICAL FIELD

The present invention relates to a method of managing a sliding region of an electrode, and more particularly, to a method of managing a sliding region of an electrode for preventing a reversal phenomenon an NP-ratio by managing the loading amount and thickness of an electrode mixture layer according to a local position where a positive electrode and a negative electrode face.

### BACKGROUND ART

As technologies about mobile, automotive and energy storage devices are developed and their demands increase, the demand of batteries as an energy source has also increased rapidly. As such, many studies have been done for lithium secondary batteries having a high energy density and discharge voltage, and such lithium secondary batteries have been widely used.

The secondary battery is classified into a cylindrical battery and a prismatic battery in which an electrode assembly is embedded in a cylindrical or prismatic metal according to the shape of the battery case, and a pouch-shaped battery in which an electrode assembly is embedded in a pouch-shaped case of an aluminum laminate sheet.

Further, the electrode assembly embedded in the battery case is a power generating element capable of charging/discharging composed of a laminated structure of a positive electrode/separator/negative electrode. Representative examples thereof include a jelly-roll type electrode assembly in which long sheet type positive electrodes and negative electrodes are wound with a separator interposed therebetween, a stacked electrode assembly in which a plurality of positive and negative electrodes cut in a predetermined size unit are sequentially stacked with a separator interposed therebetween, and a stacked/foldable electrode assembly in which bi-cells or full cells, in which positive and negative electrodes of a predetermined unit are stacked with a separator interposed therebetween, are wound.

A positive electrode and a negative electrode, which constitute an electrode assembly, are manufactured by coating an electrode slurry, which is prepared in a mixing process, on an electrode current collector in a predetermined pattern and with a constant thickness through a slot die, and then drying the electrode slurry. However, since the electrode slurry is a fluid, it flows down after being coated, and such a flowing down of the electrode slurry is called sliding. Such a sliding may frequency occur at both ends in the width direction of the coated part on which an electrode active material has been coated. Likewise, a portion, where the thickness of the slurry coating layer gradually changes to thereby form a slant part, is called a sliding region.

The sliding region is shown within 30 mm or 20 mm from the boundary line of the non-coated part toward the coated part. As shown in FIG. 1, the length of the sliding region of the negative electrode may be different from that of the positive electrode, and the shape of the sliding region may be a straight line or a curve. Further, the slopes of the sliding regions of the positive electrode and the negative electrode may be different. As such, there may be a portion where there is an imbalance in the NP-ratio, depending on the position where the positive electrode and the negative electrode face, and the imbalance of the NP-ratio may cause a safety accident such as a short circuit by lithium precipitation in the negative electrode. For this reason, there is a need for a method for managing the NP-ratio in the sliding region of an electrode, but there has been no standardized method for determining or measuring the sliding of an electrode.

Therefore, there is a need for such a technology.

### DISCLOSURE

### Technical Problem

The present invention is believed to solve at least some of the above problems. For example, an aspect of the present invention provides a method of managing a sliding region of an electrode for preventing the NP-ratio reversal in a sliding region of an electrode.

### Technical Solution

A method of managing a sliding region of an electrode for solving the problems includes: (a) a process of determining a specific region where a positive electrode and a negative electrode, which are subjects of management to be used in manufacturing an electrode assembly, face each other and setting a measurement location in the specific region; (b) a process of measuring a thickness and a loading amount of each electrode mixture layer of the positive electrode and the negative electrode at the set measurement location; (c) a process of measuring a thickness and a loading amount of an electrode mixture layer at each central portion of the positive electrode and the negative electrode; and (d) a process of calculating a ratio of the thickness of the electrode mixture layer of the positive electrode and the negative electrode measured in the process (b) to the thickness of the central portion measured in the process (c).

The method of managing a sliding region of an electrode further includes (e) a process of calculating a ratio (NP-ratio) of a capacity per unit area of the negative electrode to a capacity per unit area of the positive electrode at the measurement location.

In an embodiment of the present invention, the process (e) includes: (e-1) a process of accumulating correlation data of a loading amount of the positive electrode and the negative electrode, a ratio of thickness of each of the positive electrode and the negative electrode, and the NP-ratio, by repeating the processes of (a) through (d) while changing the measurement location for the positive electrode and the negative electrode for a specimen; (e-2) a process of deriving a correlation equation by analyzing the accumulated data; and (e-3) a process of calculating the NP-ratio by substituting the loading amount measured in the process (b) and the ratio of the thickness calculated in the process (d) into the correlation equation for the positive electrode and the negative electrode, which are subjects of management.

In an embodiment of the present invention, the process (a) includes setting a plurality of measurement locations (X₁, X₂ . . . Xₙ) at regular intervals along a width direction (x-axis) on a center line in a longitudinal direction of the electrode. At this time, the method may further include a process of further setting a plurality of measurement locations at regular intervals along a longitudinal direction (y axis) of the electrode, at each point of the measurement locations (X₁, X₂ . . . Xₙ).

In another embodiment of the present invention, the process (a) includes: (a-1) a process of making an image for a plurality of vertical lines at regular intervals along a width direction (x-axis) of the electrode at the specific region; (a-2) a process of making an image for a plurality of horizontal lines at regular intervals along a longitudinal direction (y-axis) in the set sliding region; (a-3) a process of setting a plurality of rectangular regions formed by intersection of the vertical lines and the horizontal lines as segmented regions; and (a-4) setting respective arbitrary points within the set segmented regions as measurement locations. At this time, each interval of the plurality of vertical lines of the process (a-1) and each interval of the plurality of horizontal lines of the process (a-2) is in the range of 0.05 to 0.2 mm.

In an embodiment of the present invention, the process (b) and the process (c) may include measuring a thickness of the electrode mixture layer by using rotary calipers.

In an embodiment of the present invention, the process (b) may include measuring the loading amount of the electrode mixture layer by using a web gauge.

In an embodiment of the present invention, the positive electrode and the negative electrode of the process (b) are an electrode which is obtained by applying an electrode slurry containing an electrode active material on a current collector and then drying the electrode slurry.

In an embodiment of the present invention, the positive electrode and the negative electrode of the process (b) is an electrode before going through a rolling process.

### Advantageous Effects

The present invention provides a method of easily managing an NP-ratio through the measurement of the thickness and loading amount of the electrode mixture layer in a positive electrode and a negative electrode including a sliding region of an electrode.

### BRIEF DESCRIPTION OF THE DRAWINGS

FIG. 1 is a diagram illustrating a difference between the length of the sliding region of a positive electrode and the length of the sliding region of a negative electrode.

FIG. 2 is a flowchart of a method of managing a sliding region of an electrode according to one embodiment of the present invention.

FIG. 3 is a flowchart of a method of managing a sliding region of an electrode according to another embodiment of the present invention.

FIG. 4 is a plan view and a cross-sectional view showing a sliding region of an electrode.

FIG. 5 is a schematic diagram showing a part of the process of measuring the thickness of an electrode mixture layer.

FIGS. 6 to 8 are schematic diagrams illustrating a process of setting a measurement location according to various embodiments of the present invention.

### DETAILED DESCRIPTION OF THE PREFERRED EMBODIMENTS

Hereinafter, the present invention will be described in detail with reference to the drawings. The terms and words used in the present specification and claims should not be construed as limited to ordinary or dictionary terms and the inventor may properly define the concept of the terms in order to best describe its invention. The terms and words should be construed as meaning and concept consistent with the technical idea of the present invention.

In this application, it should be understood that terms such as “include” or “have” are intended to indicate that there is a feature, number, step, operation, component, part, or a combination thereof described on the specification, and they do not exclude in advance the possibility of the presence or addition of one or more other features or numbers, steps, operations, components, parts or combinations thereof. Also, when a portion such as a layer, a film, an area, a plate, etc. is referred to as being “on” another portion, this includes not only the case where the portion is “directly on” the another portion but also the case where further another portion is interposed therebetween. On the other hand, when a portion such as a layer, a film, an area, a plate, etc. is referred to as being “under” another portion, this includes not only the case where the portion is “directly under” the another portion but also the case where further another portion is interposed therebetween. In addition, to be disposed “on” in the present application may include the case disposed at the bottom as well as the top.

In the present invention, the NP-ratio is defined as a value obtained by dividing the total capacity of the negative electrode by the total capacity of the positive electrode.

In the present invention, the sliding region refers to a region where the thickness of the electrode mixture layer gradually decreases toward a non-coated part in a region around the boundary between the non-coated part on which the electrode mixture layer (positive electrode mixture layer and negative electrode mixture layer) has not been applied, and the coated part on which the electrode mixture layer has been applied. Namely, the sliding region should be understood as a portion where the flatness of the electrode mixture layer decreases and its neighboring portion in a region around the boundary between of the coated part and the non-coated part.

Hereinafter, the present invention will be described in detail with reference to the drawings.

Conventionally, the NP-ratio of the electrode has been managed through the thickness and the loading amount in the central portion of the electrode. Such a management method may be used in a flat portion where the thickness of each of the positive electrode mixture layer and the negative electrode mixture layer is constant. However, in the case that the length of each sliding region of the positive electrode and the negative electrode, where a sliding has occurred, is different, and the decrease rate of the thickness of the positive electrode mixture layer in each sliding region of the positive electrode and the negative electrode is different from the decrease rate of the thickness of the negative electrode mixture layer in each sliding region of the positive electrode and the negative electrode, it is difficult to determine whether there has been a reversal of the NP-ratio by using a conventional management method.

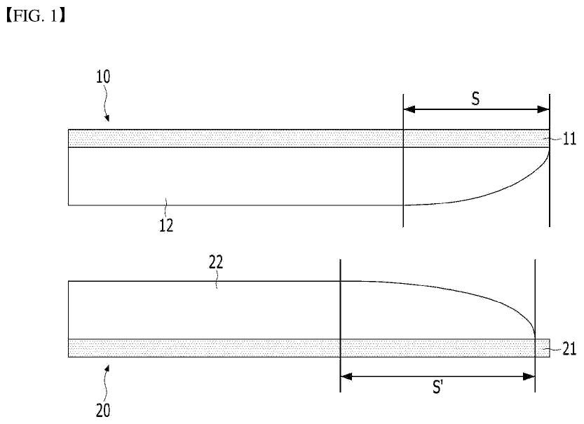

FIG. 1 is a diagram illustrating a difference between the length of the sliding region of a positive electrode and the length of the sliding region of a negative electrode. Referring to FIG. 1, a positive electrode mixture layer 12 of a positive electrode 10 faces a negative electrode mixture layer 22 of a negative electrode 20, and the positive electrode mixture layer 12 and the negative electrode mixture layer 22 each has a sliding region (S or S′) where the thickness gradually decreases in a direction extended toward the non-coated part at the end portion. As described above, since the electrode slurry is a fluid, such a sliding region is frequently generated in the boundary region between the coated part and the non-coated part due to the flowing property of the electrode slurry.

Generally, when the NP-ratio is equal to or greater than 1, lithium is not precipitated during charge/discharge, and particularly, the battery is not rapidly deteriorated during high rate charge/discharge. Hence, when designing an electrode assembly, it is designed to allow the NP-ratio to be equal to or greater than 1. In the case that the positive electrode and the negative electrode include a sliding region, a reversal phenomenon of the NP-ratio, in which the NP-ratio becomes less than 1 locally, depending on the length of the sliding region, the shape (curve or straight line) of the sliding region, or the slope, may occur.

In order to calculate the NP-ratio in the sliding region, it is an accurate method to calculate the NP-Ratio considering the loading amount, the thickness, the capacity of the active material, and tolerance, etc. at the position where the positive electrode faces the negative electrode for positive electrode and negative electrode which are subjects of management, but it is not easy to calculate NP-ratio in the sliding region for all products at the time of mass production.

As such, the present invention provides a new method of managing the NP-ratio by measuring the thickness of the positive electrode mixture layer and the thickness of the negative electrode mixture layer in the sliding region when at least one of the positive electrode and the negative electrode includes at least one sliding region in the region where the positive electrode faces the negative electrode.

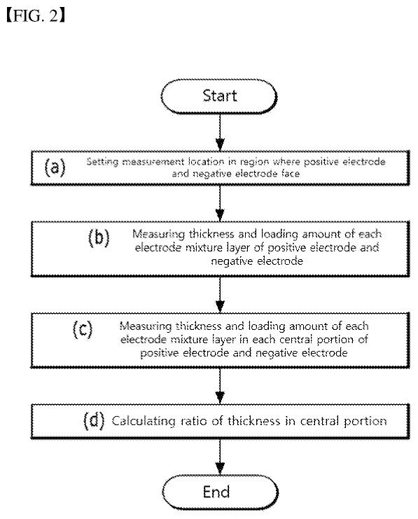

FIG. 2 is a flowchart of a method of managing a sliding region of an electrode according to one embodiment of the present invention. Referring to FIG. 2, a method of managing a sliding region of an electrode of the present invention includes: (a) a process of determining a specific region where a positive electrode and a negative electrode, which are subjects of management to be used in manufacturing an electrode assembly, face each other and setting a measurement location in the specific region; (b) a process of measuring a thickness and a loading amount of each electrode mixture layer of the positive electrode and the negative electrode at the set measurement location; (c) a process of measuring a thickness and a loading amount of an electrode mixture layer at each central portion of the positive electrode and the negative electrode; and (d) a process of calculating a ratio of the thickness of the electrode mixture layer of the positive electrode and the negative electrode measured in the process (b) to the thickness of the central portion measured in the process (c).

First, the process (a) will be described. The process (a) is a process of determining a region where a positive electrode and a negative electrode, which are subjects of management, face each other and setting measurement locations for measuring the thickness and the loading amount of each of the positive electrode mixture layer and the negative electrode mixture layer in the determined region when assembling an electrode assembly with the positive electrode and the negative electrode.

Since the object of the present invention is to locally prevent the reversal of the NP-ratio in the sliding region, the process (a) is to set the measurement location in the position where the positive electrode and the negative electrode face each other of the sliding region.

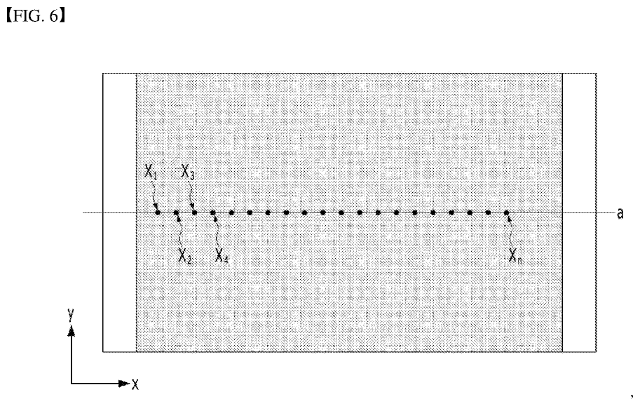

FIGS. 6 to 8 show measurement locations which are set according to various embodiments of the present invention.

First, referring to FIG. 6, the process (a) may include setting a plurality of measurement locations (X₁, X₂ . . . Xₙ) at regular intervals along a width direction (x-axis) on a center line in a longitudinal direction of the electrode in the region whether the positive electrode faces the negative electrode. Further, the process (b) to be described later is performed at the set measurement locations.

At this time, the separation distance between the plurality of measurement locations may be in the range of 0.05 to 2 mm, preferably 0.07 to 1 mm, and more preferably in the range of 0.1 to 0.5 mm.

Some of the measurement locations are positioned at the sliding region, some others may be positioned at a region other than the sliding region.

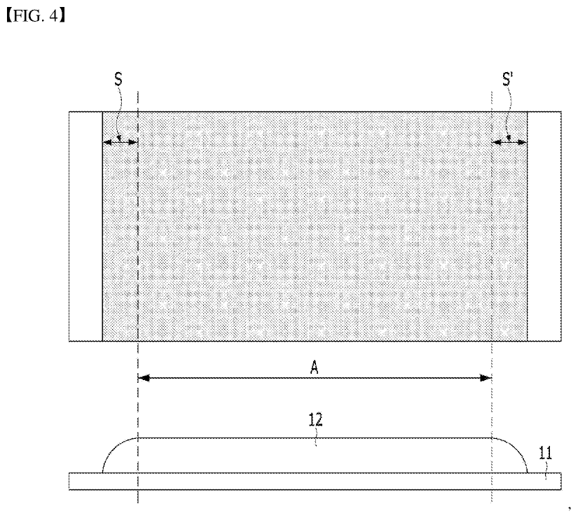

The sliding region is a region where the thickness of the electrode mixture layer decreases toward the non-coated part, and the thickness of the electrode mixture layer increases toward the coated part, and the thickness of the electrode mixture layer continuously changes according to the measurement location in the sliding region. Hence, it is preferable that the interval between measurement locations, which are set by the process (a), are relatively small in the sliding region for more accurate management. Further, as shown in FIG. 4, in the portion A other than the sliding region (S and S′), the thickness of the electrode mixture layer may be constant in the measurement locations even if the measurement locations are changed. Therefore, it is not a problem that the interval between the measurement locations is relatively large in the region (A) of the electrode mixture layer except for the sliding region (S and S′). It is preferable that the interval between measurement locations in the region other than the sliding region is greater than the interval between measurement locations in the sliding region, for quick and efficient management.

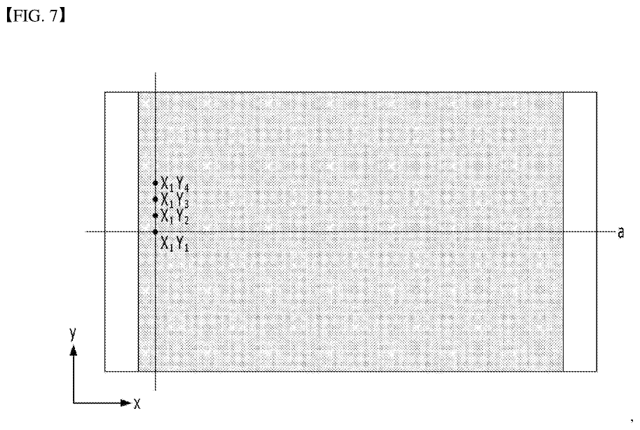

According to another embodiment of the present invention, the method may further include a process of further setting a plurality of measurement locations at regular intervals along a longitudinal direction (y axis) of the electrode, at each point of the measurement locations (X₁, X₂ . . . Xₙ). Referring to FIG. 7, P1(X₁,Y₁), P2(X₂,Y₂), P3(X₃,Y₃), P4(X₄,Y₄) . . . , which are measurement locations at regular intervals in the y-axis direction on the basis of X₁ among the measurement locations set as described above, may be set. Only 4 points of P1(X₁,Y₁), P2(X₂,Y₂), P3(X₃,Y₃) and P4(X₄,Y₄) were illustrated in FIG. 7, but the present invention is not limited to these examples and measurement locations may be further added or reduced.

In another embodiment of the present invention, the process (a) includes: (a-1) a process of making an image for a plurality of vertical lines at regular intervals along a width direction (x-axis) of the electrode at the specific region; (a-2) a process of making an image for virtual horizontal lines extended in a width direction at regular intervals along a longitudinal direction (y-axis) in the set sliding region; (a-3) a process of setting a plurality of rectangular regions formed by intersection of the vertical lines and the horizontal lines as segmented regions; and (a-4) setting respective arbitrary points within the set segmented regions as measurement locations.

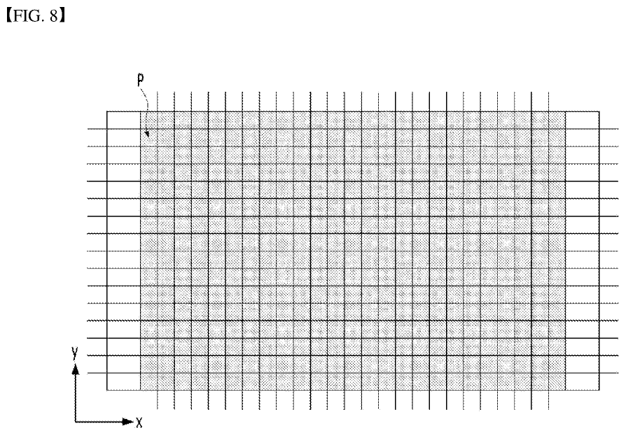

Referring to FIG. 8, the region, where the positive electrode and the negative electrode face each other, may be divided into a plurality sub-regions as a plurality of horizontal lines parallel to the width direction of the electrode and a plurality of vertical lines parallel to the longitudinal direction in the region cross each other. Further, an arbitrary point P in an arbitrary segmented region among the plurality segmented regions may be set as the measurement location.

At this time, the separation distance between the vertical lines and the separation distance between the horizontal lines may be in the range of 0.05 to 2 mm, preferably 0.07 to 1 mm, and more preferably 0.1 to 0.5 mm.

Likewise, it is possible to set a plurality of points, where the positive electrode face the negative electrode, as measurement locations, but it takes a lot of efforts and costs if there are too many measurement locations. Hence, in the process (a), it is possible to set a center point of the sliding region of the positive electrode and a point of the negative electrode mixture layer facing the center point, and a center point of the sliding region of the negative electrode and a point of the positive electrode mixture layer facing the center point, as measurement locations. Herein, the center of the sliding region refers to the point corresponding to ½ in the x-axis direction in the sliding region.

Specifically, point 1 corresponding to ½ of the sliding region of the positive electrode and a point of the negative electrode mixture layer facing the point 1 are set as the measurement location, and point 2 corresponding to ½ of the sliding region of the negative electrode and a point of the positive electrode mixture layer facing the point 2 are set as the measurement location.

The process (b) will be described below. The process (b) of the present invention is a process of measuring the thickness and the loading amount of each electrode mixture layer of a positive electrode and a negative electrode which are main elements for managing the NP-ratio of an electrode. The process (b) of the present invention includes measuring the thickness of the positive electrode mixture layer of the positive electrode and the loading amount of the positive electrode, and the thickness of the negative electrode mixture layer of the negative electrode and the loading amount of the negative electrode in measurement locations which are set in the process (a).

Further, the positive electrode, which is the subject of measurement, is an electrode which is obtained by applying a positive electrode slurry containing a positive electrode active material on a positive electrode current collector and then drying the slurry, and the negative electrode is an electrode which is obtained by applying a negative electrode slurry containing a negative electrode active material on a negative electrode current collector and then drying the slurry. Since the electrode active material layer is in a fluid state right after coating an electrode slurry on a current collector, it is difficult to measure the thickness by using a thickness measuring instrument. Hence, the thickness is measured after drying the electrode active material layer to some extent.

Further, the positive electrode and the negative electrode may be an electrode before or after the rolling process. However, if the thickness of the electrode mixture layer is measured for the electrode having gone through the rolling process, the electrode mixture layer including the sliding region is entirely pressed during the rolling process, and accordingly the thickness deviation on the sliding region may not be large. As such, it may be preferable to use a thickness measuring instrument capable of measuring the thickness in micrometer units.

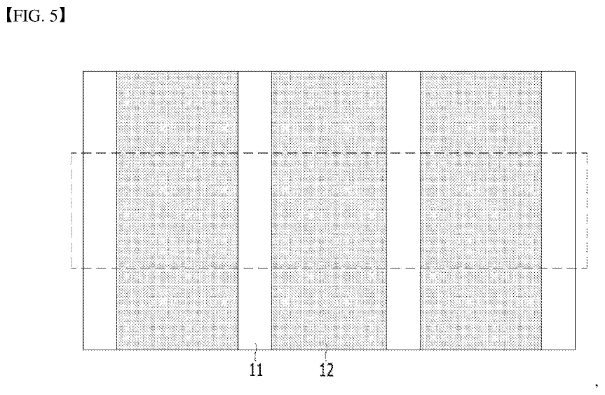

In an embodiment of the present invention, the process (b) may include measuring a thickness of the electrode mixture layer by using rotary calipers. Referring to FIG. 5, after cutting the positive electrode or/and the negative electrode which are subjects of management as shown in FIG. 5, the cut sheet may be put in rotary calipers to then measure the thickness of the electrode mixture layer at the set measurement locations and the thickness of the electrode mixture layer in the central portion to be described later.

Further, in an embodiment of the present invention, the process (b) may include measuring the loading amount of the electrode mixture layer by using a web gauge.

Further, in an embodiment of the present invention, the process (b) may include calculating the loading amount of the electrode mixture layer by using an electrode loading design value.

The process (c) will be described below. The process (c) is a process of measuring a thickness of an electrode mixture layer at each central portion of the positive electrode and the negative electrode which are subjects of management. This is the process required to calculate the ratio of the thicknesses of the process (d). At this time, the thickness of the electrode mixture layer may be measured by using rotary calipers as in the process (b).

Herein, each central portion of the positive electrode and the negative electrode means a portion which is not a sliding region and where the thickness of the electrode mixture layer is constant. When coating the electrode slurry, the sliding region is shown in both ends in the width direction due to the fluid characteristic of the slurry, and the thickness of the coated part except for the sliding region is constant. Hence, since the thickness of the electrode mixture layer in the center in the width direction of the electrode is the same as the thickness of the electrode positioned close to the coated part of the sliding region, the process of measuring the thickness of the electrode at each central portion of the positive electrode and the negative electrode may be a process of measuring the thickness of the electrode mixture layer close to the coated part of the sliding region, which is not the sliding region.

Herein, the thickness of the electrode mixture layer in the central portion means the thickness of the electrode mixture layer at a location which does not belong to the sliding region, and may specifically be a thickness at a point spaced apart from the boundary between the non-coated part and the coated part by 5 to 15 mm, 15 to 20 mm, 10 to 30 mm, or 20 to 30 mm.

This is because the sliding region of the electrode may have a length of 5 to 15 mm, 15 to 20 mm, 10 to 30 mm, or 20 to 30 mm from the boundary between the coated part and the non-coated part toward the coated part, and the thickness of the electrode mixture layer except for the sliding region is almost constant.

Hence, the process (c) may be a process of measuring the thickness of the electrode mixture layer at a point placed away from the boundary between the coated part and the non-coated part by 5 to 15 mm, 15 to 20 mm, 10 to 30 mm, or 20 to 30 mm.

The process (d) will be described below. The process (d) is a process of calculating a ratio of the thickness of the electrode mixture layer of the positive electrode and the negative electrode measured in the process (b) to the thickness of the central portion measured in the process (c). The NP-ratio at a local location can be managed using the ratio (T_{(P-n)}/T_{(P-center)}) of the thickness T_{(P-n)} of the positive electrode mixture layer measured at the set location to the thickness T_{(P-center)} at the central portion of the positive electrode mixture layer measured by the above-described process (c), and the ratio (T_{(N-center)}/T_{(N-n)}) of the thickness T_{(N-n)} of the positive electrode mixture layer measured at the set location to the thickness T_{(N-center)} of the central portion of the negative electrode mixture layer measured by the process (c).

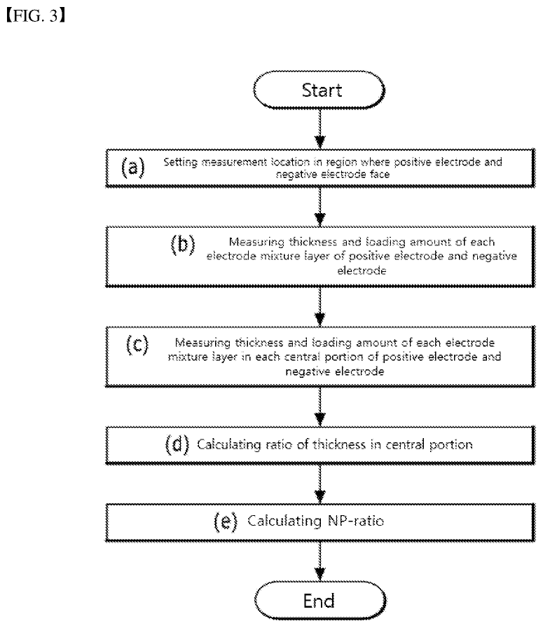

FIG. 3 is a flowchart of a method of managing a sliding region of an electrode according to another embodiment of the present invention. Referring to FIG. 3, the method of managing a sliding region of an electrode of the present invention further includes (e) a process of calculating a ratio (NP-ratio) of a capacity per unit area of the negative electrode to a capacity per unit area of the positive electrode at the measurement location where the positive electrode faces the negative electrode. The process (e) includes using big data in order to calculate the NP-ratio using factors of the loading amount and the ratio of thicknesses by measurement locations calculated through the above-described processes (a) to (d) for a positive electrode and a negative electrode which are subjects of management.

In one specific example, the process (e) includes: (e-1) a process of accumulating correlation data of a loading amount of the positive electrode and the negative electrode, a ratio of thickness of each of the positive electrode and the negative electrode, and the NP-ratio, by repeating the above-described processes (a) to (d) while changing the measurement location for the positive electrode and the negative electrode for a specimen; (e-2) a process of deriving a correlation equation by analyzing the accumulated data; and (e-3) a process of calculating the NP-ratio by substituting the loading amount measured in the process (b) and the ratio of the thickness calculated in the process (d) into the correlation equation for the positive electrode and the negative electrode which are subjects of management.

First, in the process (e-1), positive electrodes and negative electrodes, which have the same size as that of the positive electrode and the negative electrode as subjects of management, are prepared as specimens, and processes (a) to (d) are repeated for these specimens, and the loading amount and the thickness ratio for each measurement location of each of the positive electrode and the negative electrode are calculated and stored. Further, data about NP-ratios, which are calculated for each measurement location based on the obtained information on the loading amount and the thickness ratio according to a known method, are accumulated. The NP-ratio may be calculated in 4 kinds of schemes of 1) positive electrode charge amount and negative electrode discharge amount, 2) positive electrode charge amount and negative electrode charge amount, 3) positive electrode discharge amount and negative electrode discharge amount, and 4) positive electrode discharge amount and negative electrode charge amount.

Further, the process (b-2) includes deriving a correlation function between a ratio of each loading amount of the positive electrode and the negative electrode to each thickness of the positive electrode and the negative electrode, and the NP-ratio. At this time data may be analyzed using a r method, but the present invention is not limited to this example.

The process (e-3) includes calculating the NP-ratio by substituting the loading amount anc the ratio of the thicknesses of each of the positive electrode and the negative electrode which are subjects of management into the correlation equation derived in the process (e-2). As such, according to the present invention, it is possible to easily recognize whether there has been a reversal phenomenon of the NP-ratio in a region including a sliding region which is difficult to be managed as it becomes possible to calculate the NP-ratio by measuring the loading amount and the thickness ratio for each location of the positive electrode and the negative electrode which are subjects of management.

Further, it is possible to derive the maximum thickness of the positive electrode in the sliding region and the minimum thickness of the negative electrode in the sliding region by substituting the reference value of the designed SP-ratio into a correlation function of the NP ratio, a loading amount of each of the positive electrode and the negative electrode and the ratio of the thickness of each of the positive electrode and the negative electrode which are derived by the process (b-2). Further, the reversal of the NP-ratio can be prevented by allowing the thickness of the positive electrode mixture layer to be equal to or less than the maximum thickness and the thickness of the negative electrode mixture layer to be equal to or greater than the minimum thickness, in a sliding region.

The above description is merely illustrative of the technical idea of the present invention, and those skilled in the art to which the present invention pertains may make various modifications and variations without departing from the essential characteristics of the present invention. Therefore, the drawings disclosed in the present invention are not intended to limit the technical idea of the present invention but to describe the present invention, and the scope of the technical idea of the present invention is not limited by these drawings. The scope of protection of the present invention should be interpreted by the following claims, and all technical ideas within the scope equivalent thereto should be construed as being included in the scope of the present invention.

1. A method of managing a sliding region of an electrode, the method comprising:
(a) determining a specific region where a positive electrode and a negative electrode that are configured to together form an electrode assembly, face each other and setting a measurement location in the specific region;
(b) measuring a thickness and a loading amount of an electrode mixture layer of the positive electrode and an electrode mixture layer of the negative electrode at the measurement location;
(c) measuring a thickness and a loading amount of each respective electrode mixture layer at a central portion of the positive electrode and the negative electrode; and
(d) calculating a ratio of the thickness of the electrode mixture layer of the positive electrode and the electrode mixture layer of the negative electrode measured during step (b) to the thickness of each respective electrode mixture layer at the central portion measured during step (c).

2. The method of claim 1, further comprising:
(e) calculating an NP-ratio of a capacity per unit area of the negative electrode to a capacity per unit area of the positive electrode at the measurement location.

3. The method of claim 2, wherein step (e) comprises:
(e-1) accumulating correlation data between a ratio of each loading amount of the positive electrode and the negative electrode to each thickness of the positive electrode and the negative electrode, and the NP-ratio, by repeating steps (a) through (d) while changing the measurement location for the positive electrode and the negative electrode;
(e-2) deriving a correlation equation by analyzing the correlation data;
(e-3) calculating the NP-ratio by substituting a ratio of the loading amount measured during step (b) to the thicknesses calculated during step (d) into the correlation equation.

4. The method of claim 1, wherein step (a) includes setting the measurement location at which the positive electrode faces the negative electrode in the sliding region.

5. The method of claim 1, wherein step (a) includes setting a plurality of measurement locations (X₁, X₂ . . . Xₙ) at regular intervals along a width direction (x-axis) on a center line in a longitudinal direction of each electrode.

6. The method of claim 5, further comprising setting a plurality of measurement locations at regular intervals along a longitudinal direction (y axis) of each electrode, at each point of the measurement locations (X₁, X₂ . . . Xₙ).

7. The method of claim 1, wherein step (a) comprises:
(a-1) making an image for a plurality of vertical lines at regular intervals along a width direction (x-axis) of the electrode at the specific region;
(a-2) making an image for a plurality of horizontal lines at regular intervals along a longitudinal direction (y-axis) in the sliding region;
(a-3) setting a plurality of rectangular regions formed by intersection of the vertical lines and the horizontal lines as segmented regions; and
(a-4) setting respective points within the set segmented regions as measurement locations.

8. The method of claim 5, wherein the plurality of measurement locations (X₁, X₂ . . . Xₙ) are spaced apart from each other at an interval of 0.05 to 0.2 mm.

9. The method of claim 1, wherein step (b) and step (c) each include measuring a thickness of each electrode mixture layer by using rotary calipers.

10. The method of claim 1, wherein step (b) includes measuring the loading amount of the electrode mixture layer by using a web gauge.

11. The method of claim 1, wherein the positive electrode and the negative electrode are each formed by applying an electrode slurry containing an electrode active material on a current collector and then drying the electrode slurry.

12. The method of claim 11, wherein each of the positive electrode and the negative electrode have not gone through a rolling process at the time of step (b).
